(19) United States
(12) Patent Application Publication
(10) Pub. No.: US 2009/0193939 A1
(43) Pub. Date: Aug. 6, 2009

(54) Ratchet Wrench

(75) Inventors: Light Chiu, Taichung (TW); Robert St. John, Cheshire, CT (US)

Correspondence Address: PILLSBURY WINTHROP SHAW PITTMAN, LLP, P.O. BOX 10500, MCLEAN, VA, 22102, US

(73) Assignee: THE STANLEY WORKS, New Britain, CT (US)

(21) Appl. No.: 12/027,103

(22) Filed: Feb. 6, 2008

(51) Int. Cl. B25B 13/46; B25B 13/12

(52) U.S. Cl. 81/60; 81/155

(57) ABSTRACT

A wrench adapted to engage a workpiece to drive the workpiece rotationally. In one embodiment, the wrench comprises a head, a first jaw, and a second jaw. The first jaw carried by the head and forms a first workpiece engaging surface. The second jaw is carried by the head and forms a second workpiece engaging surface such that (i) if the head is rotated about a workpiece disposed between the first workpiece engaging surface and the second workpiece engaging surface in a first rotational direction, the first workpiece engaging surface and the second workpiece engaging surface rotationally drive the workpiece in the first rotational direction, and (ii) if the head is rotated about the workpiece disposed between the first workpiece engaging surface and the second workpiece engaging surface in a second rotational direction opposite from the first rotational direction, the first workpiece engaging surface and the second workpiece engaging surface slide along the workpiece as the head rotates in the second rotational direction independent from the workpiece.

### RELATED APPLICATIONS

The instant application is related to U.S. Patent Application No. (Attorney Docket No. 081712-0366901), which is entitled “Ratchet Wrench,” and has been filed concurrently with the instant application. The contents of the related application are hereby incorporated by reference into the instant application

### FIELD OF THE INVENTION

The invention relates to ratchet wrenches, including ratchet wrenches that are open-ended and/or adjustable to engage workpieces with different sizes.

### BACKGROUND OF THE INVENTION

Various ratchet wrenches are known. However, most ratchet designs are for closed-end wrenches, wrenches that encompass the circumference of a workpiece. In some circumstances, due to tight working quarters for example, use of a closed-end wrench to drive a workpiece may be precluded. As an alternative to a closed-end wrench, an open-ended wrench may be used.

While some designs for open-ended ratchet wrenches exist, these designs may be expensive to manufacture, be prone to breakage, not ratchet smoothly, and/or suffer from other drawbacks. Further, these types of wrenches are usually adapted for use with workpieces of a single size. Thus, in order to drive workpieces of different sizes with an open-ended ratchet wrench, a user will typically be required to use a plurality of different wrenches (with each wrench corresponding to a certain workpiece size).

### SUMMARY

One aspect of the invention relates to a wrench adapted to engage a workpiece to drive the workpiece rotationally. In one embodiment, the wrench comprises a handle, a head, a jaw, a pawl carriage, and a pawl. The head is connected to the handle. The jaw extends from the head, and forms a first workpiece engaging surface. The pawl carriage is disposed on the head such that the position of the pawl carriage is adjustable along a first path to enable the wrench to accommodate workpieces of different sizes. The pawl is carried by the pawl carriage, wherein the pawl is slidable on the pawl carriage along a second path between a first position and a second position, the second path being transverse to the first path, and wherein the pawl forms a second workpiece engaging surface. The first workpiece engaging surface and the second workpiece engaging surface are configured to grasp a workpiece therebetween if the pawl is at the first position, and to drive the workpiece in a first rotational direction if the head is driven in the first rotational direction by the handle. If the head is driven by the handle in a second rotational direction the engagement between the second workpiece engaging surface and the workpiece applies a force to the pawl that slides the pawl from the first position toward the second position, which releases the workpiece from the grasp of the first workpiece engaging surface and the second workpiece engaging surface and enables the head to be rotated independently from the workpiece in the second rotational direction.

Another aspect of the invention relates to a wrench adapted to engage a workpiece to drive the workpiece rotationally. In one embodiment, the wrench comprises a head, a first jaw, and a second jaw. The first jaw carried by the head and forms a first workpiece engaging surface. The second jaw is carried by the head and forms a second workpiece engaging surface such that (i) if the head is rotated about a workpiece disposed between the first workpiece engaging surface and the second workpiece engaging surface in a first rotational direction, the first workpiece engaging surface and the second workpiece engaging surface rotationally drive the workpiece in the first rotational direction, and (ii) if the head is rotated about the workpiece disposed between the first workpiece engaging surface and the second workpiece engaging surface in a second rotational direction opposite from the first rotational direction, the first workpiece engaging surface and the second workpiece engaging surface slide along the workpiece as the head rotates in the second rotational direction independent from the workpiece. The second jaw comprises a pawl carriage, and a pawl. The position of the pawl carriage is adjustable on the head to enable the first workpiece engaging surface and the second workpiece engaging surface to rotationally drive workpieces of different sizes. The pawl is carried slidably on the pawl carriage and is actuated with respect to the pawl carriage by rotation of the head in the second rotational direction to enable the first workpiece engaging surface and the second workpiece engaging surface slide along the workpiece as the head rotates in the second rotational direction independent from the workpiece.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a wrench, according to one embodiment of the invention.

FIG. 2 illustrates an exploded view of a wrench, in accordance with one embodiment of the invention.

FIG. 3 illustrates a section view of a head of a wrench, according to one embodiment of the invention.

FIG. 4 illustrates a wrench driving a workpiece, according to one embodiment of the invention.

FIG. 5 illustrates a wrench ratcheting about a workpiece, according to one embodiment of the invention.

### DETAILED DESCRIPTION

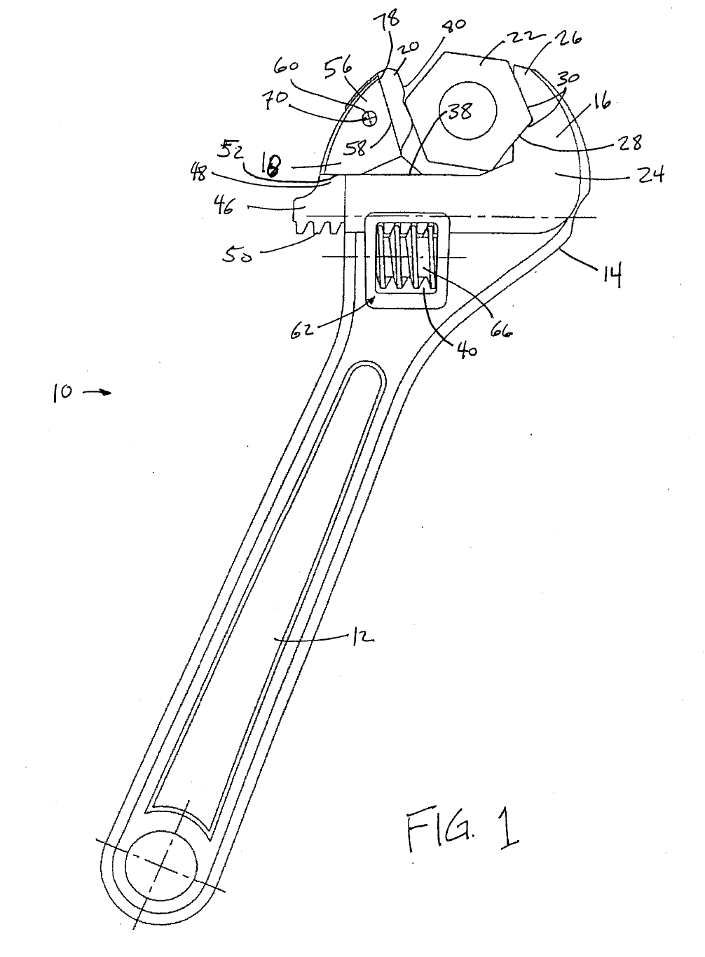

FIG. 1 illustrates a wrench 10 according to one or more embodiments of the invention. Wrench 10 includes a handle 12, a head 14, a jaw 16, a pawl carriage 18, and a pawl 20. Jaw 16 and pawl 20 are configured to engage the head of a workpiece 22 to rotationally drive the workpiece 22 as head 14 is driven by a user to rotate around workpiece 22 in a first direction (clockwise in FIG. 1). As can be seen in FIG. 1, wrench 10 is an “open-end” wrench, which may enable wrench 10 to engage workpieces in some circumstances in which the use of a “closed-end” wrench (e.g., a box-end wrench, a socket wrench, etc.) is inhibited. As is discussed further below, pawl carriage 18 is disposed movably on head 14 such that the position of pawl 20 is adjustable to enable wrench 10 to be adapted for engagement of workpiece heads with different sizes. Pawl 20 is disposed on pawl carriage 18 such when workpiece 22 is engaged by jaw 16 and pawl 20, and head 14 is driven by the user to rotate around workpiece 22 in a second direction (counter-clockwise in FIG. 1), the engagement between workpiece 22 and wrench 10 is released so that wrench 10 ratchets around workpiece 22 in the second direction.

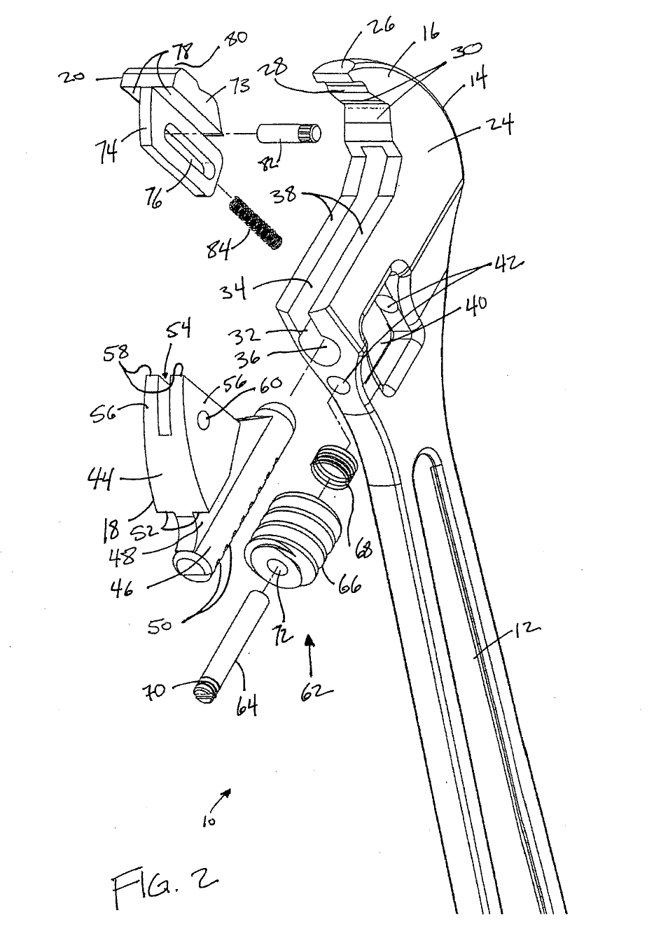

FIG. 2 is an illustration of an exploded view of wrench 10. As can be seen in FIG. 2, head 14 is disposed at one end of handle 12. Jaw 16 protrudes away from handle 12 on one side of head 14. Jaw 16 extends from a base 24 (where jaw 16 connects with head 14) to a distal end 26. A first workpiece engaging surface 28 is formed on jaw 16 running between base 24 of jaw 16 to distal end 26 and facing toward pawl 20 when wrench 10 is assembled. First workpiece engaging surface 28 includes a workpiece seat 30 adapted to seat workpiece 22 therein while workpiece 22 is driven by wrench 10. For example, in one embodiment, workpiece seat 30 is adapted to seat a corner of a hexagonal workpiece head.

A carriage track 32 is formed in head 14 as a slot with a relatively narrow guide opening 34 that communicates with a wider channel 36. In one embodiment, guide opening 34 is formed as two substantially parallel surfaces that face each other and channel 36 is formed having a circular cross section. In addition to being open at guide opening 34, track 32 is also open on a side of head 14 opposite from jaw 16. Track 32 runs from the side of head 14 opposite from jaw 16 toward base 24 of jaw 16. On either side of guide opening 34 of track 32, carriage guide surfaces 38 are formed as planar surfaces. In the embodiment illustrated in FIG. 2, carriage guide surfaces 38 are parallel. However, this is not intended to be limiting. For instance, carriage guide surfaces 38 may be formed to incline toward or away from each other.

Head 14 further forms a window 40 that passes through head 14 transverse to track 32 such that window 40 communicates with a portion of channel 36. In one embodiment, the cross-section of window 40 is generally rectangular, with chamfered corners. A conduit 42 is formed in head 14 that runs generally parallel to channel 36 and passes through window 40.

Pawl carriage 18 includes a body 44, a threaded runner 46, and an intermediate portion 48 that connects body 44 with runner 46. Runner 46 is disposed at the base of body 44, has an elongated, generally cylindrical shape, and is configured to fit within channel 36. A set of threads 50 are formed as a set of teeth that run along the side of runner 46 opposite intermediate portion 48. Intermediate portion 48 is somewhat narrower than runner 46 or body 44, which enables intermediate portion 48 to fit slidably within guide opening 34. Body 44 forms a pair of surfaces 52 adjacent to either side of intermediate portion 48 that run alongside the length of intermediate portion 48 and sit on pawl guide surfaces 38 when pawl carriage 18 is disposed on head 14.

As can be seen in FIG. 2, body 44 of pawl carriage 18 forms a pawl track 54 on a side of pawl carriage 18 that faces jaw 16 which pawl carriage is disposed on head 14. Track 54 is formed as a groove between a pair of walls 56. Track 54 further includes a pawl guide surface 58 formed on each of walls 56. Pawl guide surfaces 58 face jaw 16, and, in one embodiment, are formed as parallel, planar surfaces. A hole is 60 formed in pawl carriage 18 that runs from one side of pawl carriage 18 to the other transverse to the groove of track 54 such that hole 60 communicates with the groove on the inner surface of each of walls 56.

In one embodiment, wrench 10 includes a worm drive 62 that includes an axle 64, a worm 66, and a biasing mechanism 68. Axle 64 is configured to be seated within conduit 42 such that axle 64 runs through window 40 generally parallel with channel 36. Axle 64 includes a set of threads 70 at one end, and is retained within conduit 42 by an engagement between threads 70 and a set of threads formed at the opening of conduit 42. Worm 66 includes a central opening 72 along its axis of rotation, and is disposed within window 40 so that it can be manually rotated by a user about the axis of rotation. Worm 66 is retained within window 40 by axle 64, which is received through central opening 72 of worm 66. Biasing mechanism 68 provides a bias that forces worm 66 toward one side of window 40. This may reduce backlash as worm 66 is rotated by the user.

When pawl carriage 18 is disposed on head 14 and worm drive 62 is assembled within window 40, the threads of worm 66 are engaged with threads 50 on runner 46. If no rotational force is being applied by a user to worm 66 to rotate worm 66 about axle 64, this engagement holds pawl carriage 18 in position on track 32. If the user rotates worm 66 about axle 64, then the threads of worm 66 mesh with threads 50 and drive pawl carriage 18 to slide along track 32.

As was mentioned above, during operation, surfaces 52 on pawl carriage 18 sit on carriage guide surfaces 38. Thus, as pawl carriage 18 is driven along track 32 by worm drive 62, pawl carriage 18 moves along an path that is parallel to guide surfaces 38. As should be appreciated from FIG. 2, the path of pawl carriage 18 is further defined by the path of guide opening 34 along guide surface 38. Generally, this path runs from the side of head 14 opposite jaw 16 toward base 14 of jaw 16, and enables the spacing between pawl carriage 18 and jaw 16 to be adjusted to accommodate workpieces with different sized heads.

As can be seen in FIG. 2, pawl 20 includes a body 73 and a tab 74 extending therefrom on one side. An elongated opening 76 is formed in tab 74 that runs along tab 74. Body 73 forms a pair of surfaces 78 that are adjacent to either side of tab 74. On a side of body 73 opposite from tab 74 and surfaces 78, a second workpiece engaging surface 80 is formed that is adapted to engage the head of workpiece 20 with first workpiece engaging surface 28.

When wrench 10 is assembled, tab 74 is seated slidably within the groove of track 54 between walls 56 of carriage body 44. In this position, surfaces 78 rest on pawl guide surfaces 58. A pin 82 is inserted through hole 60 in body 44. Pin 82 is also received by opening 76 through tab 74, as the width of opening 76 corresponds to the thickness of pin 82. The reception of pin 82 through opening 76 retains tab 74 within track 54. However, as opening 76 has an elongated shape that runs along tab 74, pawl 20 is able to slide along pawl guide surfaces 58 with pin 82 disposed through opening 76 as pin 82 slides along opening 76.

More particularly, when assembled, pawl 20 slides along an path defined by (e.g., parallel to) pawl guide surface 38. The motion of pawl 20 along the path is between a first position, at which pawl 20 is closest to runner 46 of pawl carriage 18 (e.g., as shown in FIG. 1), and a second position, at which pawl 20 is farthest from runner 46.

As can be appreciated from FIG. 2, the path of pawl carriage 18 and the path of pawl 20 are transverse to each other. In the embodiment shown in FIG. 2, an angle between these axes of motion is the same as an angle between carriage guide surfaces 38 and pawl guide surfaces 58. Due to the different functionalities provided by the mobility of each of carriage 18 and pawl 20 (e.g., adjustability of size provided by carriage 18 and ratcheting provided by pawl 20), the angle between the axes of motion of pawl carriage 18 and pawl 20 may be approximately 90°. For example, in one embodiment, this angle is between about 75° and about 120°. As another example, in one embodiment, the angle between the axes of motion of pawl carriage 18 and pawl 20 is between about 80° and about 110°.

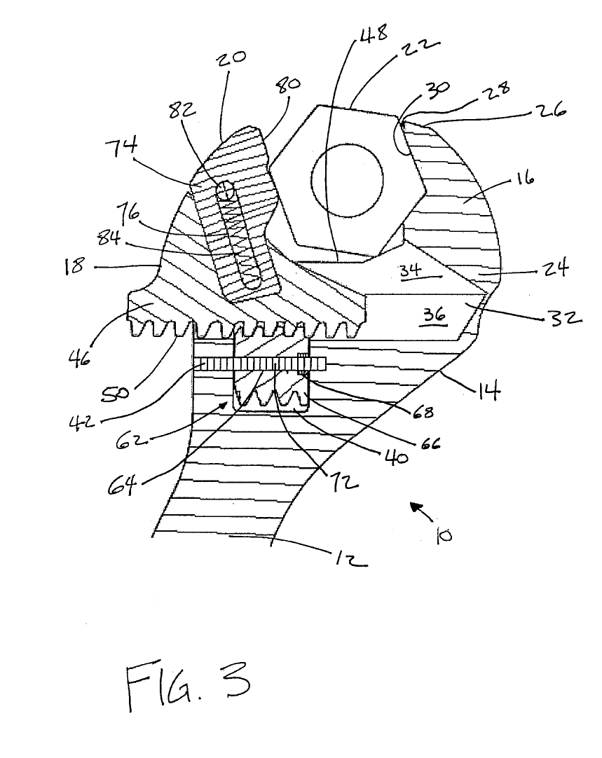

FIG. 2 further illustrates a biasing member 84 that is disposed in wrench 10 to bias pawl 20 toward the first position (e.g., toward runner 46 of pawl carriage 18). Biasing member 84 may include a spring, a rubber component, and/or some other elastic component capable of providing a bias to pawl 20. FIG. 3, which illustrates a section view of head 14, shows how, in one embodiment, biasing member 84 is seated within pawl carriage 18 to provide the appropriate bias to pawl 20. More particularly, biasing member 84 is disposed in track 54 within opening 76 formed by tab 74. One end of biasing member 84 engages pin 82, and the other end of biasing member 84 engages an edge of elongated opening 76 at the end of opening 76 closest to runner 46 of pawl carriage 18. In the view shown in FIG. 3, pawl 20 is at its first position. If pawl 20 is slid out of the first position toward the second position (e.g., away from runner 46), biasing member 84 is compressed (further than in the view shown in FIG. 3) between pin 82 and the edge of opening 76. As a result of this compression, biasing member 84 provides a bias to tab 74 (at the edge of opening 76) that pushes tab 74 back toward runner 46, thereby biasing pawl 20 toward the first position.

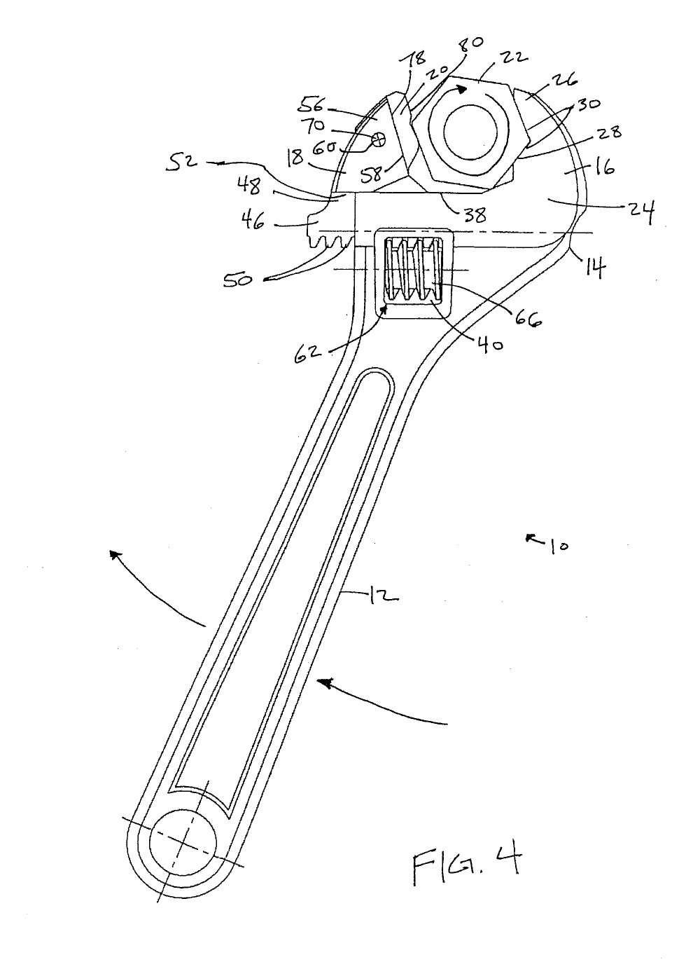

FIG. 4 illustrates wrench 10 driving workpiece 22. As can be appreciated from FIG. 4, if a user engages handle 12 and drives head 14 to rotate about workpiece 22 in a first direction (clockwise in FIG. 4), the head of workpiece 22 applies a force to pawl 20 at second workpiece engaging surface 80 that would tend to push pawl 20 toward runner 46. Since pawl 20 is already in the first position (due to the bias applied by biasing member 84), pawl 20 is not able to slide any further toward runner 46. Thus, the engagement between the head of workpiece 22 and pawl 20 as head 14 is rotated in the first direction around workpiece 20 will cooperate with the engagement between the head of workpiece 20 and jaw 16 to drive workpiece 22 to rotate in the first direction.

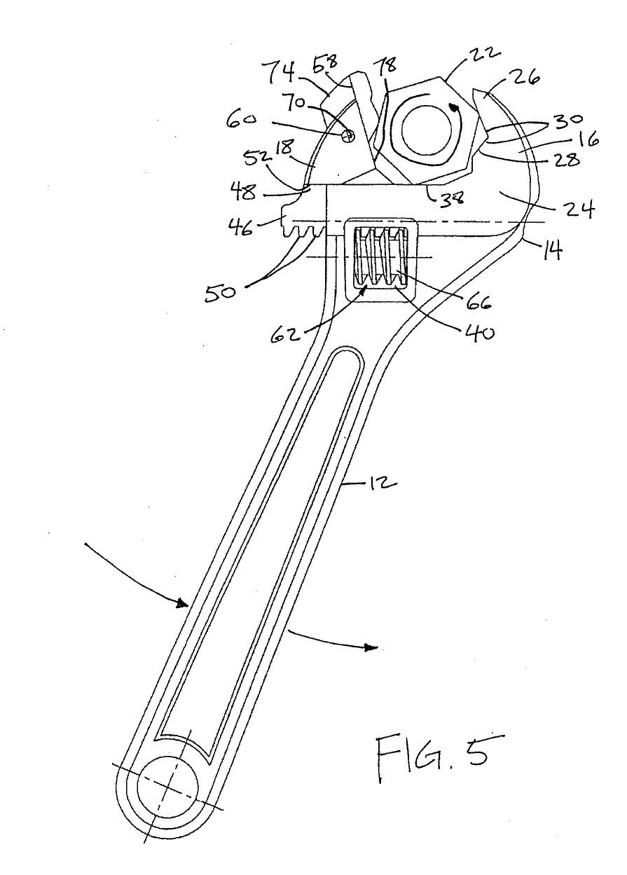

FIG. 5 illustrates wrench 10 ratcheting about workpiece 22. As can be appreciated from FIG. 5, if the user drives head 14 to rotate about workpiece 22 in a second direction (counter-clockwise in FIG. 5), the head of workpiece 22 applies a force to pawl 20 at second workpiece engaging surface 80 that pushes pawl 20 away from runner 46. As was discussed above, pawl 20 is slidable along pawl carriage 18 from its first position toward a second position further away from runner 46. Thus, the force applied to pawl 20 by the head of workpiece 22 at second workpiece engaging surface 80 causes pawl 20 to slide along its path from its first position toward its second position. As pawl 20 slides toward its second position, the head of workpiece 22 is released from its engagement with pawl 20 such that head 14 of wrench 10 can be rotated in the second direction independently from the head of workpiece 22, which remains rotationally fixed.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A wrench adapted to engage a workpiece to drive the workpiece rotationally, the wrench comprising:
a handle;
a head connected to the handle;
a jaw that extends from the head, the jaw forming a first workpiece engaging surface;
a pawl carriage disposed on the head such that the position of the pawl carriage is adjustable along a first path to enable the wrench to accommodate workpieces of different sizes; and
a pawl that is carried by the pawl carriage, wherein the pawl is slidable on the pawl carriage along a second path between a first position and a second position, the second path being transverse to the first path, and wherein the pawl forms a second workpiece engaging surface,
the first workpiece engaging surface and the second workpiece engaging surface being configured to grasp a workpiece therebetween if the pawl is at the first position, and to drive the workpiece in a first rotational direction if the head is driven in the first rotational direction by the handle, and wherein if the head is driven by the handle in a second rotational direction the engagement between the second workpiece engaging surface and the workpiece applies a force to the pawl that slides the pawl from the first position toward the second position, which releases the workpiece from the grasp of the first workpiece engaging surface and the second workpiece engaging surface and enables the head to be rotated independently from the workpiece in the second rotational direction.

2. The wrench of claim 1, further comprising a worm drive rotationally mounted in the head, wherein the pawl carriage comprises a set of threads that are engaged with the worm drive such that as the worm drive is rotated, the worm drive applies a force to the threads that causes the pawl carriage to slide along the first path.

3. The wrench of claim 1, further comprising a biasing mechanism that biases the pawl into the first position.

4. The wrench of claim 1, wherein the first position of the pawl is closer to a base of the pawl carriage than the second position of the pawl.

5. The wrench of claim 1, wherein the pawl carriage forms a groove, and wherein the pawl comprises a tab that is slidably seated within with groove.

6. The wrench of claim 4, wherein the pawl carriage comprises a pair of walls that form the groove, with each of the wall forming a hole that communicates with the groove, wherein the tab of the pawl forms an elongated opening, and wherein the wrench further comprises a pin seated within each of the holes formed in the pawl carriage and the elongated opening formed in the pawl, thereby retaining the tab of the pawl within the groove formed in the pawl carriage.

7. The wrench of claim 5, further comprising a biasing mechanism seated within the elongated opening formed in the tab of the pawl, the biasing mechanism engaging the tab of the pawl and the pin and biasing the pawl into the first position.

8. The wrench of claim 1, wherein the jaw is formed at a fixed position on the head.

9. The wrench of claim 1, wherein the handle, the head, and the jaw are formed integrally as a single piece.

10. The wrench of claim 1, wherein the first rotational direction is a tightening direction and the second rotational direction is a loosening direction.

11. A wrench adapted to engage a workpiece to drive the workpiece rotationally, the wrench comprising:
a head;
a first jaw carried by the head, the first jaw forming a first workpiece engaging surface;
a second jaw carried by the head, the second jaw forming a second workpiece engaging surface such that (i) if the head is rotated about a workpiece disposed between the first workpiece engaging surface and the second workpiece engaging surface in a first rotational direction, the first workpiece engaging surface and the second workpiece engaging surface rotationally drive the workpiece in the first rotational direction, and (ii) if the head is rotated about the workpiece disposed between the first workpiece engaging surface and the second workpiece engaging surface in a second rotational direction opposite from the first rotational direction, the first workpiece engaging surface and the second workpiece engaging surface slide along the workpiece as the head rotates in the second rotational direction independent from the workpiece, the second jaw comprising:
a pawl carriage, the position of which is adjustable on the head to enable the first workpiece engaging surface and the second workpiece engaging surface to rotationally drive workpieces of different sizes; and
a pawl carried slidably on the pawl carriage that is actuated with respect to the pawl carriage by rotation of the head in the second rotational direction to enable the first workpiece engaging surface and the second workpiece engaging surface slide along the workpiece as the head rotates in the second rotational direction independent from the workpiece.

12. The wrench of claim 11, wherein the position of the pawl carriage is adjustable along a first path.

13. The wrench of claim 12, wherein the pawl is slidable along the pawl carriage along a second path that is transverse to the first path.

14. The wrench of claim of claim 11, further comprising a worm drive rotationally mounted in the head, wherein the pawl carriage comprises a set of threads that are engaged with the worm drive such that as the worm drive is rotated, the worm drive applies a force to the threads that causes the position of the pawl carriage on the head to be adjusted.

15. The wrench of claim 11, wherein the pawl is slidable on the pawl carriage between a first position and a second position, wherein the pawl is positioned in the first position if the head is rotated about the workpiece in the first rotational direction and a force applied by the workpiece to the second workpiece engaging surface forces the pawl toward the second position if the head is rotated about the workpiece in the second rotational direction.

16. The wrench of claim 15, further comprising a handle connected to the head, wherein the first position of the pawl is closer to the handle than the second position.

17. The wrench of claim 15, further comprising a biasing mechanism that biases the pawl toward the first position.

18. The wrench of claim 11, wherein the pawl carriage forms a groove, and wherein the pawl comprises a tab that is slidably seated within with groove.

19. The wrench of claim 18, wherein the pawl carriage comprises a pair of walls that form the groove, with each of the wall forming a hole that communicates with the groove, wherein the tab of the pawl forms an elongated opening, and wherein the wrench further comprises a pin seated within each of the holes formed in the pawl carriage and the elongated opening formed in the pawl, thereby retaining the tab of the pawl within the groove formed in the pawl carriage.

20. The wrench of claim 11, wherein the first jaw is formed at a fixed location on the head.

21. The wrench of claim 11, wherein the first rotational direction is a tightening direction and the second rotational direction is a loosening direction
